(19) United States
(12) Patent Application Publication
(10) Pub. No.: US 2023/0276755 A1
(43) Pub. Date: Sep. 7, 2023

(54) Irrigation Program Server, Cloud, Gateway System for Individual Control of Irrigation Heads

(71) Applicant: Yoram Kenig, North Wales, PA (US)

(72) Inventor: Yoram Kenig, North Wales, PA (US)

(21) Appl. No.: 18/131,297

(22) Filed: Apr. 5, 2023

(51) Int. Cl. A01G 25/16

(52) U.S. Cl. CPC A01G 25/16

(57) ABSTRACT

An unlimited number of water control valves and moisture sensors may be installed during original construction and/or during a retrofitting of an irrigation system. Individual control valves may have a downstream side distributing water or otherwise providing or controlling irrigation. The control valves may have an upstream side or control side being connected to an irrigation program server, the irrigation program server eschewing the need or use of a central controller, by providing individual control to each control valve. Wireless and energy efficient valve control may be provided by using a vault and buoy system sending and receiving information and instructions to a gateway with the gateway in wireless communion with a cloud storage and communication system with in turn may be wirelessly in connection with a irrigation program server. An end consumer may use a smart phone or other device to program and/or monitor irrigation functions.

### RELATED PATENT APPLICATION AND INCORPORATION BY REFERENCE

NA

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever. Such trademarks may include “CELIS” and “INDN.”

### BACKGROUND OF THE INVENTION

### Field of the Invention

The invention generally relates to cloud-based control of irrigation systems. More particularly, the invention relates to the fabrication and use of irrigation program servers, cloud or remote data storage systems, gateway systems, wireless communication systems with water control vaults that are sometimes submerged in water. The disclosed embodiments also relate to artful means of conserving battery life and/or minimizing power consumption at the consumer point of contact and/or local control valves and sensors.

### Description of the Related Art

U.S. Pat. U.S. Pat. 10,697,814 by Kenig discloses an artful system and method of using a buoy in wired connection to a submerged water controller and the buoy in wireless connection to a radio transmitter. While the ’814 Patent continues to be an industry leader in irrigation head communication in a submerged environment, the ’814 Patent fails to disclose or anticipate the disclosed above ground communication systems, data systems, valve systems, dual storage for programs and power conservation systems.

The known prior art is devoid of wireless systems that allow a consumer to use a smartphone to control, program and monitor water distribution at the individual level of each water controller/valve and/or moisture sensor. The know prior art is devoid a means or methods of storing an individualized irrigation program in both the independent communication controller of each irrigation head and within a remote database storage system, with the individualized irrigation program originating from either the consumer’s smart phone or an irrigation program server.

### BRIEF SUMMARY OF THE INVENTION

The present invention overcomes shortfalls in the related art by presenting an unobvious and unique combination, configuration and use of components that eschew the use of a central irrigation control to provide seamless, wireless and energy efficient control, monitoring and programing of individual water irrigation heads and individual moisture meters. The disclosed embodiments overcome shortfalls in the related art by enabling end users to have granular control of irrigation heads and sensors by direct communication, (such as web-based) with an irrigation program server or by wireless communion with on onsite irrigation vault with such wireless communication possible by use of a smart phone or other consumer device. Thus, a consumer may log into a web interface to access an irrigation program server or more typically use Wi-Fi or Bluetooth via a smartphone to communicate with the onsite water vault, with the onsite water vault transmitting the desired program to the cloud database for more secure and retrievable storage.

From the water vault or communication buoy system as found in U.S. Pat. 10,697,814 a consumer’s signal is transmitted to a system gateway, wherein the system gateway transmits to a cloud or remote data storage system, from the cloud system the signal may be in communication with an irrigation program server. The irrigation program server may accept changes to the programing of individual irrigation valves.

The disclosed embodiments further overcome shortfalls in the known related art by providing a redundancy or safety system by providing means and methods for each independent communication controller to hold a local irrigation program that mirrors the program held in the irrigation program server. This feature of dual storage overcomes shortfalls in the related art as the local copy of the program provides functionality to the irrigation system in the event of a loss of communication with the irrigation program server and an individual controller.

### BRIEF DESCRIPTION OF THE DRAWINGS

FIG. 1 is a schematic view of a disclosed embodiment

### REFERENCE NUMERALS IN THE DRAWINGS

100 gateway or other system in communication with an irrigation head or IH

200 a cloud-based database in communication with a gateway and irrigation program server

300 irrigation program server in communication with a cloud-based database 200

400 smartphone or other consumer device in communication with an irrigation head system 500

500 irrigation head system or vault system

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

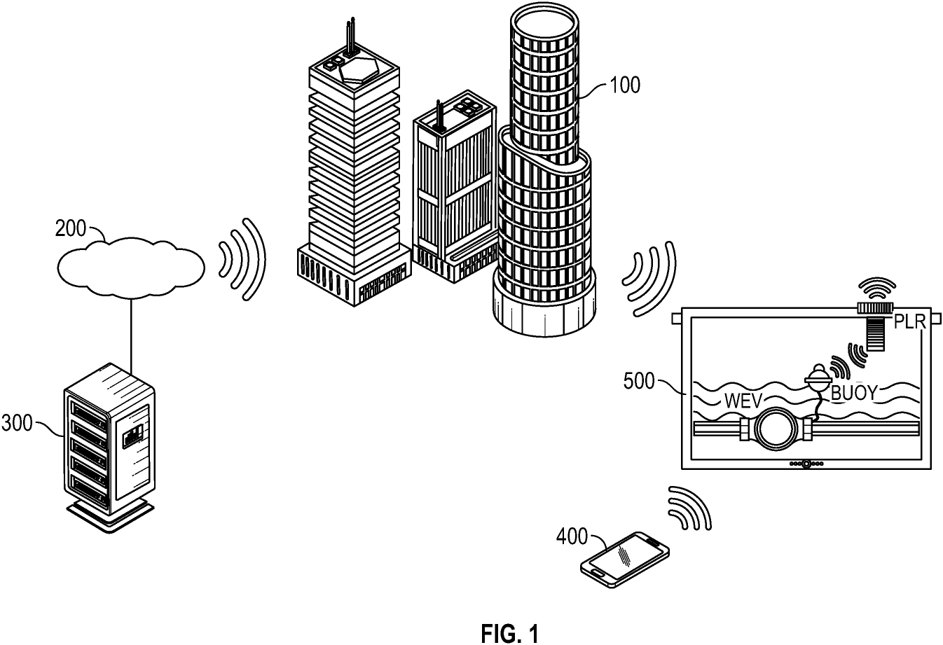

Referring to FIG. 1, an irrigation head system 500 may comprise WEV or wireless electric valve or a plurality of such valves. Such valves may be submerged in water and in wired communication with a buoy with the buoy wirelessly transmitting valve signals to a vault radio or vault radio antenna. A home or other site for irrigation my comprise a plurality of irrigation head systems 500. The vault radio antenna may be in communication with a smartphone 400 and/or with a gateway 100.

A gateway 100 may comprise a system in communication with the irrigation head system 500 and the gateway may be in further communication with a cloud-based database system 200 or other offsite system.

An irrigation program server 300 maybe in communication with a cloud-based data system 200.

In general, the disclosed embodiments comprise a system for controlled irrigation where all functions, such as irrigation control and moisture sensor readings are executed without the use or need of a prior art central irrigation controller. The disclosed communication systems are wireless and may be devoid of any AC or DC power supplies.

Each irrigation head may be connected wirelessly though a gate-way cloud 200 where each induvial program for each individual irrigation head resides. Each irrigation head may have an independent communication controller which also stores a local irrigation program as well. The dual storage of the local irrigation program overcomes shortfalls in the related art in energy conservation and back-up of irrigation programs and data. With the disclosed dual storage system, only changes in the local irrigation program or alarms are reported, saving battery life of any batteries powering the irrigation head system 500 or vault system.

The disclosed embodiments overcome shortfalls in the related art as the disclosed systems of controlled irrigation enable the use of an unlimited number of specifically controlled valves and sensors to be installed anywhere with minimal effort and at low cost as compared to the prior art. The disclosed embodiments, such as the irrigation head system 500 are more reliable and energy efficient than the prior art such that the disclosed embodiments will operate for many years without the need for an outside energy source such as a 110 VAC or solar panel. Moreover, the disclosed connectivity of the disclosed embodiments allow for a consumer to use a smartphone for easy programing, installation and maintenance of the irrigation systems.

Disclosed embodiments include Irrigation Heads, (IH) connected via a radio system or 100 gateway to a cloud 200. The Gate Way (GW) may communicate with thousands of IH or Irrigation Head units.

An Irrigation Head or IH may control four or so DC valves and/or communicate with a plurality of different sensors, measuring such variables as water flow, soil moisture, temperature, wind and other variables.

The battery life of an of a disclosed irrigation controller is 10 years, if connected to four valves that are active four times per day.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A system for programing, monitoring and controlling individual irrigation heads, the system comprising:
a) each individual irrigation head comprising an independent communication controller with each independent communication controller storing a local irrigation program;
b) each individual irrigation head in communication with an antenna, with the antenna in wireless communication with a gateway;
c) the gateway in wireless communication with a database;
d) the database in wireless communication with an irrigation program server; and
e) the database storing a copy of each local irrigation program.

2. The system of claim 1 further comprising one or more sensors, each sensor in communication with one individual irrigation head.

3. The system of claim 1 wherein a change in a local irrigation program prompts an alarm, the alarm manifested in the irrigation program server and in user smart phone.

4. The system of claim 1 further including a smartphone in communication with one or more individual irrigation heads.

5. The system of claim 4 wherein the smartphone changes a local irrigation program stored within an individual irrigation head and the changed local irrigation program is transmitted to the gateway and from the gateway transmitted to the database.

6. The system of claim 1 wherein the database is an offsite cloud database.

7. The system of claim 1 devoid of any central irrigation controller.

8. The system of claim 1 wherein a plurality of direct current valves are connected to one or more of the individual irrigation heads.
